(19) United States
(12) Patent Application Publication
(10) Pub. No.: US 2004/0095381 A1
(43) Pub. Date: May 20, 2004

(54) Graphical user interface for a remote spectrum analyzer

(76) Inventor: David H. McDowell, Honesdale, PA (US)

Correspondence Address: Joyce Kosinski, Loral Space and Communications, Ltd., Suite 303, 655 Deep Valley Drive, Rolling Hills Estates, CA, 90274, US

(21) Appl. No.: 10/294,306

(22) Filed: Nov. 14, 2002

(51) Int. Cl. G09G 5/00

(52) U.S. Cl. 345/740; 345/771

(57) ABSTRACT

Systems and software interfaces that provides a local graphical-user-interface (GUI) to a remotely located spectrum analyzer. The spectrum analyzer receives carrier signals transmitted from an orbiting spacecraft. The present systems and software interface enable a user, such as a communications technician or engineer, to efficiently and effectively retrieve information from the remotely located spectrum analyzer. Software comprising the software interface is disposed on a client computer that is coupled by way of a network and server computer to the spectrum analyzer. The software remotely controls the spectrum analyzer to locally process and analyze carrier signals on the client computer that were received by the spectrum analyzer.

### BACKGROUND

The present invention relates to communications systems and software, and more particularly to systems and software that implement a local graphical-user-interface (GUI) that provides an interface to a remotely located spectrum analyzer controlled by a server.

The assignee of the present invention is responsible for operating and controlling transponders on orbiting communication spacecraft. To ensure that the transponders operate properly and efficiently, carrier signals that are transmitted by the transponders must be analyzed and evaluated.

Such analysis is performed using a spectrum analyzer located at a ground station. Heretofore, it has been necessary for technicians to be physically located at the site of the spectrum analyzer in order for analysis to be performed. It would be desirable to allow technical analysis to be performed remotely from the spectrum analyzer.

It is therefore an objective of the present invention to provide for systems and software that implement a local graphical-user-interface (GUI) that provides an interface to a remotely located spectrum analyzer.

### SUMMARY OF THE INVENTION

The present invention provides for a system and software interface that provides a local graphical-user-interface (GUI) for a remote spectrum analyzer. The system, and software, interface enable a user, typically a communications technician or engineer, to efficiently, and effectively, retrieve information from remotely located spectrum analyzers, which may be located anywhere in the world.

An exemplary system comprises a communication antenna that is used to receive carrier signals transmitted by transponders on orbiting spacecraft that are allocated to specific customers. The communication antenna is coupled by way of RF switching apparatus to a spectrum analyzer which receives the carrier signals for processing thereby. The server computer is coupled to the spectrum analyzer and communicates therewith by way of GPIB signals. Data in the form of GPIB or discrete signals are coupled from the server computer to the RF switching apparatus to control it. The server computer is also coupled by way of a network, which may be a wide area network (WAN), such as the Internet, for example, or a local area network (LAN) to a client computer.

The software interface is implemented on the client and server computers. The server software interface transfers data from, and commands to, the spectrum analyzer. The client software interface displays plots of the carrier signals that were received by the spectrum analyzer. The software interface provides a means for technicians to remotely analyze the carrier signals on the spectrum analyzer.

A preferred and reduced to practice embodiment of the software interface has point-and-click simplicity that allows the user to quickly receive spectral plots of a customer's carrier signals on a Telstar fleet of communication spacecraft, for example, and perform appropriate technical analysis. The reduced to practice embodiment of the software defining the interface is written in Microsoft Visual Basic 6.0 and runs under Microsoft Windows 2000 and Microsoft NT operating systems.

### BRIEF DESCRIPTION OF THE DRAWINGS

The various features and advantages of the present invention may be more readily understood with reference to the following detailed description taken in conjunction with the accompanying drawing figure, described by way of example, wherein like reference numerals designate like structural elements, and in which:

FIG. 1 illustrates an exemplary carrier signal analysis system that implements a software interface in accordance with the principles of the present invention;

FIG. 2 shows an exemplary client screen display of the present invention;

FIGS. 3 and 4 show exemplary server screen displays of the present invention; and

FIG. 5 is a flow diagram of the software defining client and server software interfaces of the present invention.

### DETAILED DESCRIPTION

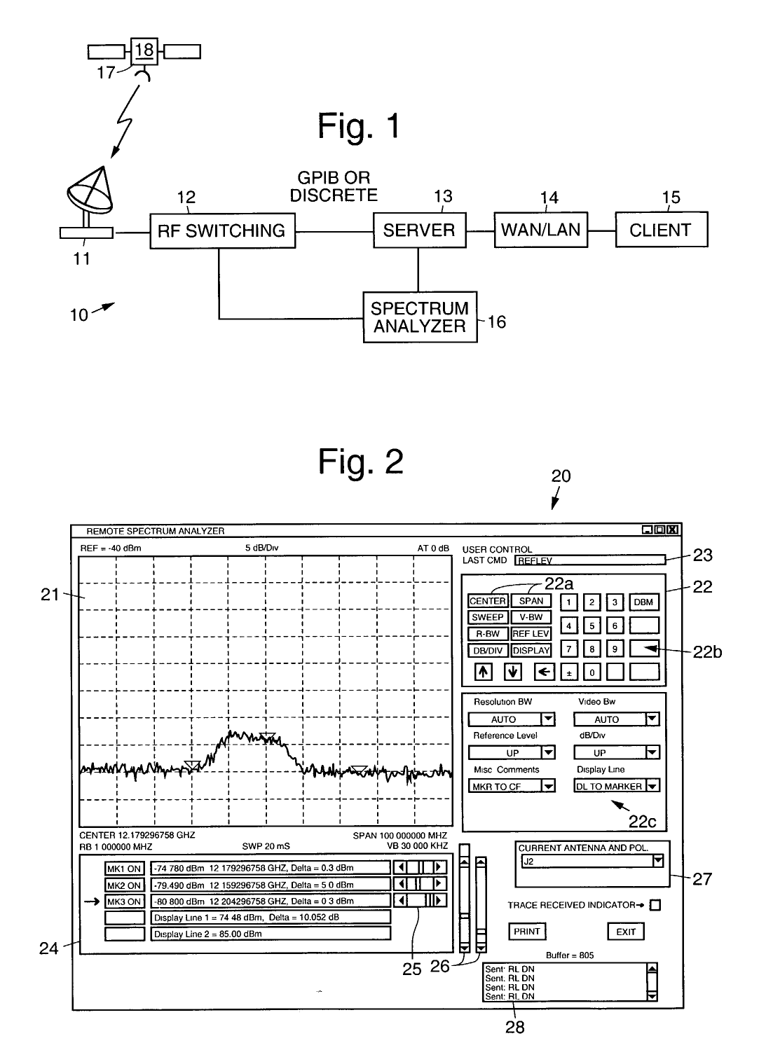

Referring to the drawing figures, FIG. 1 illustrates an exemplary carrier signal analysis system 10 that comprises a software interface 20, 30, 40 (FIGS. 2-4) in accordance with the principles of the present invention. The exemplary system 10 comprises a communication antenna 11 that is used to receive carrier signals transmitted by transponders 18 on an orbiting spacecraft 17 that are allocated to specific customers. The communication antenna 11 is coupled by way of RF switching apparatus 12 to a spectrum analyzer 16. Data in the form of GPIB, or discrete, signals are coupled from a server computer 13 to the RF switching apparatus 12. The purpose of the server computer 13 is to control the RF switching apparatus 12, control the spectrum analyzer 16, and communicate to and from a client computer 15.

The server computer 13 is coupled to the spectrum analyzer 16 and communicates therewith by way of GPIB signals. The server computer 13 is also coupled by way of a network 14, such as a wide area network (WAN) 14, including the Internet, or a local area network (LAN) 14, for example, to the client computer 15.

Software comprising a client software interface 20 is disposed on the client computer 15 and is used to remotely control the spectrum analyzer 16 by way of the network 14 and the server computer 13, which is comprised of server software interfaces 30, 40. The software and client software interface 20 allow local processing of carrier signals on the client computer 15 that were received by the spectrum analyzer 16.

The architecture of the system 10 is such that it allows for analysis and evaluation of the transponders 18 on the spacecraft 17 by technicians that are remotely located from the spectrum analyzer 16 that receives the carrier signals. Thus, using the system 10 and software interfaces 20, 30, 40, allow technical analysis relating to the carrier signals that may be performed remotely from the spectrum analyzer 16.

FIG. 2 shows an exemplary local client screen display comprising the present software interface 20. The client software interface 20 and underlying software is located and implemented on the client computer 15 that is remotely located from the spectrum analyzer 16 and the server computer 13. The client software interface 20 provides for a local graphical-user-interface (GUI) for the remotely located spectrum analyzer 16.

The client software interface 20 enables a user, such as a communications technician or engineer, to efficiently and effectively retrieve information from the remotely located spectrum analyzer 16, and remotely analyze the carrier signals in order to optimize the carrier signals to provide an efficient communication link. The client software interface 20 has point-and-click buttons and slide bars that allow a user to receive plots of carrier signals, and perform appropriate technical analysis relating to the carrier signals. The system 10 has been modeled and optimized for maximum trace information from the remote spectrum analyzer 16 to the local client computer 15, with all relevant marker and display line information processed locally on the client computer 15.

As is illustrated in the screen display shown in FIG. 2, the client software interface 20 comprises a first portion 21 of the display screen that displays a selected carrier signal to a user. The selected carrier signal is the carrier signal that is being processed by the spectrum analyzer 16.

The client software interface 20 also provides relevant commands and controls 22a in a second portion 22 of the display screen that the user can select to display the carrier signal in a preferred manner and to properly analyze the displayed carrier signal. Buttons are provided that allow selection of the center frequency of the carrier signal on the display (CENTER), the frequency span the carrier signal (SPAN), the sweep time through the carrier signal (SWEEP), the video bandwidth (V-BW), the resolution bandwidth (R-BW),the reference level (REF LEV), the scale, in decibels per division, that are displayed ((DB/DIV), and, allow control a desired reference display line (there are two) amplitude level (DISPLAY).

A numeric keypad 22b is provided in the second portion 22 that allows direct numeric entry and selection of the parameters cited above. A number of pull-down lists are provided in the second portion 22 that have pre-selected values for the parameters cited above, plus additional commands most needed by the local user. Above the second portion 22 of the display screen is a user control section 23 that indicates the last command entered by the user that was sent to the remote server computer 13.

The client software interface 20 also presents relevant additional data to the user in a third portion 24 of the display screen. Data that is displayed include marker frequencies and amplitudes, marker amplitude delta from the active display line, and display line amplitudes. Slider bars 25 are provided in the third portion 24 that permit placement of the markers. A plurality of slider bars 26 are provided to the right of the third portion 24 of the display screen that permit placement of the display lines.

A selection bar 27 is provided that allows selection of the current antenna and polarization. The current antenna refers to the chosen antenna feed and polarization at Print and Exit selection boxes are also included on the display screen and are located above the fourth portion 28 of the display screen. Clicking on Print prompts the user for title information and store the plot in electronic format for display or hard copy printout.

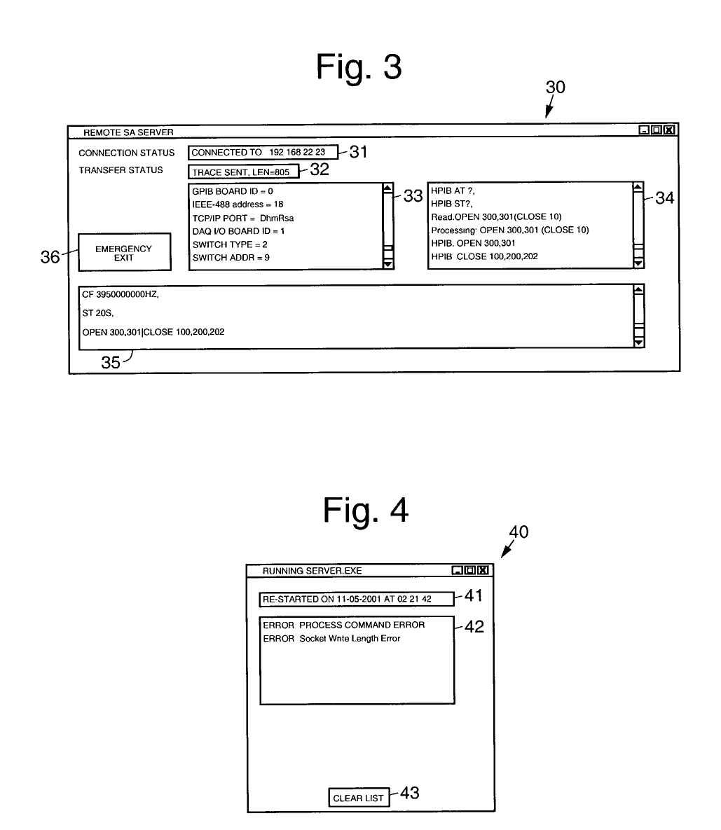

FIGS. 3 and 4 show exemplary server screen displays comprising first and second server software interfaces 30, 40. The first server software interface 30 and underlying software are located and implemented on the server computer 13. Box 31 show the IP address of the client computer 15 presently connected to and controlling the server computer 13. Box 32 shows what data is being sent from the server computer 13 to the client computer 15. Box 33 shows various startup parameters as read in by the program execution. Boxes 34 and 35 show various states of command processing status and are mainly used as an aid in solving communication problems. Box 36, when clicked on, immediately shuts down the program.

The second server software interface 40 and underlying software is located and implemented on the server computer 13. The second server software interface 40 comprises a screen display of the executive level restart program that handles automatic restarting of the first server software interface 30 if for any reason it were to shut down. This ensures reliability in the field where access to the remote site by a user would be prohibitive. State and history boxes 41, 42 show the state and history of restart events. A clear list box 43 is provided that clears the state and history boxes.

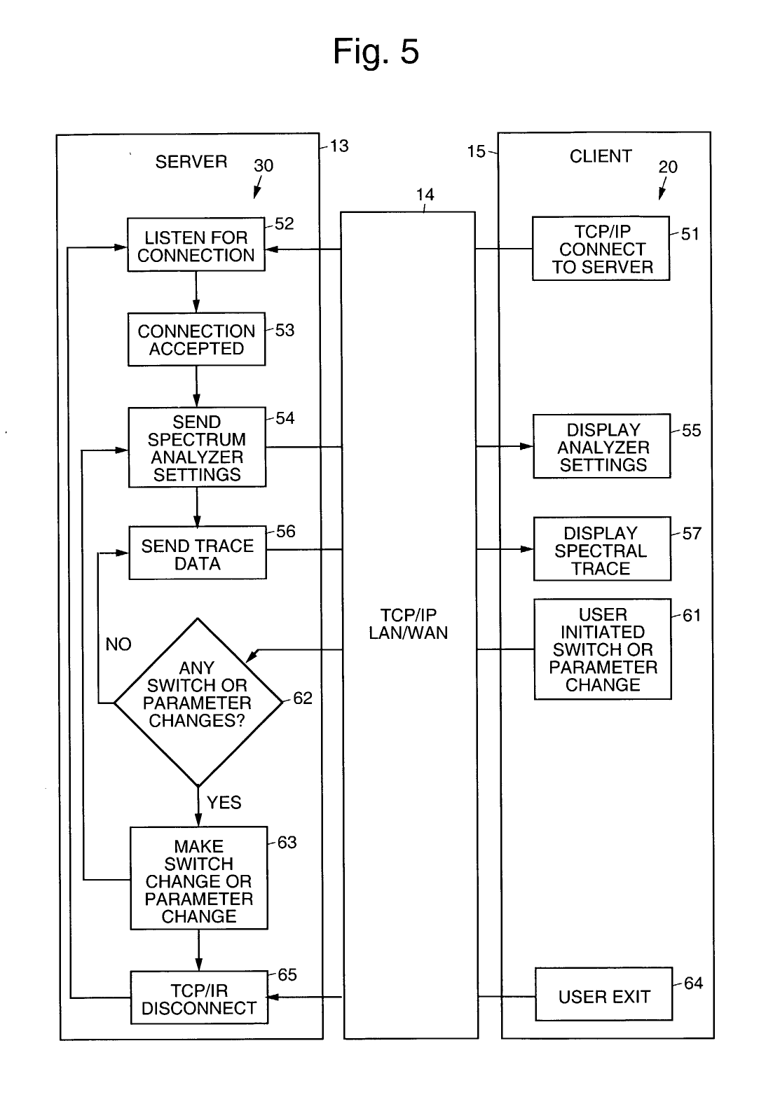

A preferred and reduced to practice embodiment of the client software interface 20 thus has point-and-click simplicity that allows the user to quickly receive spectral traces and archive plots of carrier signals transmitted by a Telstar fleet of communication spacecraft 17, for example, and perform appropriate technical analysis. The reduced to practice embodiment of the software defining the client software interface 20 is written in Microsoft Visual Basic 6.0 and runs under Microsoft Windows 2000 and Microsoft NT operating systems. A flow diagram of the software defining the client and server software interfaces 20, 30 is shown as FIG. 5.

As is shown in FIG. 5, the software 20 on the client computer 15 connects 51 to the server computer 13 and the software 30 on the server computer 13 listens 52 for the connection. The software 30 on the server computer 13 then accepts 53 the connection. The software 30 on the server computer 13 then sends 54 spectrum analyzer settings to the client computer 15 and the software 20 on the client computer 15 displays 55 the settings. The software 30 on the server computer 13 then sends 56 trace data to the client computer 15 and the software 20 on the client computer 15 displays 57 the spectral trace derived therefrom.

The user of the client computer 15 can then selectively switch between transponders 18 or make parameter changes 61. The software 30 on the server computer 13 then determines 62 if any switch or parameter changes have been made. If no switch or parameter changes have been made, trace data is sent 56 to the client computer 15. If switch or parameter changes have been made, the switch change or parameter change is made 63. Once the switch or parameter changes have been made, new spectrum analyzer settings are sent 54 to the client computer 15 and the process continues. If the user elects to exit 64, the software 30 on the server computer 13 disconnects 65 the connection between the client computer 15 and the server computer 13.

Thus, the software implementing client software interface 20 of the present invention comprises a code segment that displays a plot 21 of a received carrier signal derived from a remotely located spectrum analyzer 16. A code segment displays relevant commands and controls 22a that may be used to display the carrier signal in a desired manner on a display screen. A code segment displays a numeric keypad 22b. A code segment displays predetermined selection bars 22c relating to presentation of the carrier signal on the display screen. A code segment displays data relating to the frequency and amplitude of the carrier signal. A code segment displays print box that may be selected to print the plot of the carrier signal or the display screen. A code segment displays a selectable exit box that may be selected to exit the software.

The software implementing server software interface 30 of the present invention comprises a code segment that processes RF data from the spectrum analyzer 16 interleaved with an interpreter that handles commands from the client computer 15, such that trace data is sent to the client computer 15 unrequested. This process remains until a change command is transmitted from the client computer 15, thus maximizing the data throughput from the server computer 13 to the client computer 15. A code segment also manages software on the server computer 13 to insure that the software is automatically re-started if the server software stalls, fails, or if communication is corrupted or lost.

Thus, systems and software that implement a local graphical-user-interface (GUI) that provides an interface to a remotely located spectrum analyzer have been disclosed. It is to be understood that the described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A carrier signal analysis system, comprising:
a communication antenna for receiving carrier signals transmitted by transponders on an orbiting spacecraft;
RF switching apparatus coupled to the communication antenna;
a spectrum analyzer is coupled to the RF switching apparatus for receiving the carrier signals for processing;
a server computer coupled to the RF switching apparatus and to the spectrum analyzer for controlling RF feed and processing RF data;
a network coupled to the server computer;
a client computer coupled to the network that communicates with the server computer and the spectrum analyzer; and
software comprising a software interface disposed on the client computer that remotely controls the spectrum analyzer by way of the network and server computer, and that locally processes carrier signals on the client computer that are received by the spectrum analyzer.

2. The carrier signal analysis system recited in claim 1 wherein the software comprises:
a code segment on a client computer that displays a plot of a received carrier signal derived from a remotely located spectrum analyzer on a display screen of the client computer;
a code segment on the client computer that displays relevant commands and controls that may be selected to display the carrier signal in a desired manner on the display screen of the client computer;
a code segment on the client computer that displays a numeric keypad on the display screen of the client computer;
a code segment on the client computer that displays predetermined selection elements that are user selectable to present the carrier signal on the display screen of the client computer;
a code segment on the client computer that displays data relating to the frequency and amplitude of the carrier signal on the display screen of the client computer;
a code segment on the client computer that displays a print box on the display screen of the client computer that may be selected to print the plot of the carrier signal or the display screen; and
a code segment on the client computer that displays a selectable exit box on the display screen of the client computer for exiting the software.

3. The carrier signal analysis system recited in claim 1 further comprising software disposed on the server computer that comprises:
a code segment that processes RF data from the spectrum analyzer interleaved with an interpreter that processes commands from the client computer, such that trace data is sent to the client computer unrequested; and
a code segment that manages server software to insure that the software is automatically re-started if the server software stalls, fails, or if communication is corrupted or lost.

4. The carrier signal analysis system recited in claim 3 wherein trace data is sent to the client computer until a change command is transmitted from the client computer, thus maximizing the data throughput from the server computer to the client computer.

5. Software comprising a software interface for remotely displaying and analyzing carrier signals on a client computer received from a spectrum analyzer, comprising:
a code segment that displays a plot of a received carrier signal derived from a remotely located spectrum analyzer on a display screen of the client computer;
a code segment that displays relevant commands and controls that may be selected to display the carrier signal in a desired manner on the display screen of the client computer;
a code segment that displays a numeric keypad on the display screen of the client computer;
a code segment that displays predetermined selection elements that are user selectable to present the carrier signal on the display screen of the client computer;
a code segment that displays data relating to the frequency and amplitude of the carrier signal on the display screen of the client computer;
a code segment that displays a print box on the display screen of the client computer that may be selected to print the plot of the carrier signal or the display screen; and
a code segment that displays a selectable exit box on the display screen of the client computer for exiting the software.

6. The carrier signal analysis system recited in claim 5 further comprising software disposed on a server computer that interfaces with the spectrum analyzer, that comprises:
a code segment that processes RF data from the spectrum analyzer interleaved with an interpreter that processes commands from the client computer, such that trace data is sent to the client computer unrequested; and
a code segment that manages server software to insure that the software is automatically re-started if the server software stalls, fails, or if communication is corrupted or lost.

7. The software recited in claim 6 wherein trace data is sent to the client computer until a change command is received from the client computer, thus maximizing the data throughput from the server computer to the client computer.

8. Software comprising a software interface for remotely displaying and analyzing carrier signals received by a spectrum analyzer, comprising:
a code segment on a client computer that displays a plot of a received carrier signal derived from a remotely located spectrum analyzer on a display screen of the client computer;
a code segment on the client computer that displays relevant commands and controls that may be selected to display the carrier signal in a desired manner on the display screen of the client computer;
a code segment on the client computer that displays a numeric keypad on the display screen of the client computer;
a code segment on the client computer that displays predetermined selection elements that are user selectable to present the carrier signal on the display screen of the client computer;
a code segment on the client computer that displays data relating to the frequency and amplitude of the carrier signal on the display screen of the client computer;
a code segment on the client computer that displays a print box on the display screen of the client computer that may be selected to print the plot of the carrier signal or the display screen;
a code segment on the client computer that displays a selectable exit box on the display screen of the client computer for exiting the software;
a code segment on the server computer that processes RF data from the spectrum analyzer interleaved with an interpreter that processes commands from the client computer, such that trace data is sent to the client computer unrequested; and
a code segment on the server computer that manages server software to insure that the software is automatically re-started if the server software stalls, fails, or if communication is corrupted or lost.

9. The software recited in claim 8 wherein trace data is sent to the client computer until a change command is received from the client computer, thus maximizing the data throughput from the server computer to the client computer.
